(19) United States
(12) Patent Application Publication
(10) Pub. No.: US 2016/0128039 A1
(43) Pub. Date: May 5, 2016

(54) METHOD AND APPARATUS FOR TRANSMITTING IN MOBILE COMMUNICATION SYSTEM

(71) Applicant: Electronics and Telecommunications Research Institute, Daejeon (KR)

(72) Inventors: Kwang Jae LIM, Daejeon (KR); Sung Cheol CHANG, Daejeon (KR)

(73) Assignee: ETRI - Electronics and Telecommunications Research Institute, Daejeon (KR)

(21) Appl. No.: 14/676,455

(22) Filed: Apr. 1, 2015

(30) Foreign Application Priority Data
Oct. 29, 2014 (KR) 10-2014-0148670

(51) Int. Cl. H04W 72/04; H04L 1/18

(52) U.S. Cl. CPC H04W 72/044; H04W 72/0406; H04L 1/1812

(57) ABSTRACT

A transmitting apparatus in a mobile communication system determines a size of a Transmission Time Interval (TTI) that allocates a transmitting symbol in a minimum unit according to a quantity of data to transmit to each receiving apparatus and a latency time, allocates a control channel and a data channel in a frequency domain of a subframe including a plurality of transmitting symbols, and transmits respective control information and data to corresponding receiving apparatuses through the control channel and the data channel at the determined TTI in a radio frame including a plurality of subframes.

### CROSS-REFERENCE TO RELATED APPLICATION

This application claims priority to and the benefit of Korean Patent Application No. 10-2014-0148670 filed in the Korean Intellectual Property Office on Oct. 29, 2014, the entire contents of which are incorporated herein by reference.

### BACKGROUND OF THE INVENTION

(a) Field of the Invention

The present invention relates to a method and apparatus for transmitting in a mobile communication system. More particularly, the present invention relates to a method of transmitting and receiving control and data signals between a base station and a terminal.

(b) Description of the Related Art

In Long Term Evolution (LTE), which is a representative mobile communication system, a base station transmits with a downlink to a terminal using a Transmission Time Interval (TTI) that is defined as one time length.

When the base station transmits data to the terminal in a downlink frame, the base station transmits control and data signals through a downlink control channel and a data channel, and the terminal decodes the received data and feeds back a Hybrid Automatic Repeat Request (HARQ) response through a uplink control channel in a uplink frame to the base station, and when the feed-back HARQ response is NACK, the base station performs retransmission.

In an existing mobile communication system, a downlink frame is divided into subframes of a predetermined length, and each subframe is formed with at least one transmission symbol. A TTI is a basic time in which data is sent and received to and from an L2 layer and an L1 layer. In an existing mobile communication system, a TTI is the same as a subframe length, and thus transmission, reception, and response cannot be performed based on a time unit shorter than a subframe. In an LTE system, a length of the subframe is 1 ms, and thus because a TTI is 1 ms, the TTI is inappropriate for a service such as a real-time interactive game, virtual reality, and tactile Internet requiring a transmitting latency time shorter than 1 ms.

Further, in a HARQ process, in order for a base station to successfully transfer to a terminal with only one retransmission, after transmitting data to at least a downlink, except for at least an upper layer processing time, because a time to be consumed in a retransmitting process in a downlink and an uplink HARQ response is required, a transmitting latency time further increases. In an LTE system, for one time retransmission in a downlink, at least 8 TTIs (i.e., 8 ms) are consumed. Therefore, an existing mobile communication system is inappropriate for a service requiring a very short response time.

Further, because an existing mobile communication system uses only a TTI having one time length, the existing mobile communication system is inappropriate for various services requiring various response times.

### SUMMARY OF THE INVENTION

The present invention has been made in an effort to provide a transmitting method and apparatus appropriate to various services requiring various response times in a mobile communication system.

An exemplary embodiment of the present invention provides a method of transmitting control information and data in a transmitting apparatus of a mobile communication system. The method includes: determining a size of a Transmission Time Interval (TTI) in which a transmitting symbol allocates in a minimum unit according to a quantity of data to transmit and a required latency time; allocating a control channel and a data channel in a frequency domain of a subframe including a plurality of transmitting symbols; and simultaneously transmitting control information and data to at least one receiving apparatus through the control channel and the data channel in the determined TTI in a radio frame including a plurality of subframes.

The simultaneously transmitting of control information may include transmitting a start signal notifying the start of the control channel at a predetermined subcarrier location of a start symbol of the control channel.

The simultaneously transmitting of control information may include: transmitting a start signal at a predetermined subcarrier location of a start symbol of the control channel; and transmitting a length signal notifying a length of the control channel at a predetermined subcarrier location of a next symbol of a symbol in which the start signal is transmitted.

The simultaneously transmitting of control information may include: transmitting a start signal at a predetermined subcarrier location of a start symbol of the control channel; and transmitting a termination signal notifying termination of the control channel at a predetermined subcarrier location of a termination symbol of the control channel.

The simultaneously transmitting of control information may include multiplexing and transmitting control information of different receiving apparatuses at the determined TTI using different transmitting symbols of a control channel region.

The simultaneously transmitting of control information may include multiplexing and transmitting data of different receiving apparatuses using different subcarriers of a data channel region at the determined TTI.

The allocating of a control channel may include adding the control channel to a frequency axis using additional subcarriers.

The simultaneously transmitting of control information may include transmitting information of the added control channel using an originally set control channel.

The simultaneously transmitting of control information may include transmitting a control signal notifying that the additional control channel exists at a predetermined subcarrier location at a start symbol of the control channel.

The method may further include setting a HARQ response time of the receiving apparatus in proportion to the TTI.

The method may further include: receiving a HARQ response of the control information and data that are transmitted based on the HARQ response time from the receiving apparatus; and retransmitting the control information and data when the HARQ response is a negative response.

Another embodiment of the present invention provides an apparatus that transmits control information and data in a mobile communication system. The transmitting apparatus includes a processor and a transceiver. The processor determines a size of a Transmission Time Interval (TTI) that allocates a transmitting symbol in a minimum unit according to a quantity of data to transmit to each receiving apparatus, and a required latency time and allocates a control channel and a data channel in a frequency domain of a subframe including a plurality of transmitting symbols. The transceiver transmits respective control information and data to corresponding receiving apparatuses through the control channel and the data channel at the determined TTI in a radio frame including a plurality of subframes.

The processor may transmit a start signal notifying the start of the control channel through the transceiver at a predetermined subcarrier location of a start symbol of the control channel.

The processor may transmit a start signal notifying the start of the control channel through the transceiver at a predetermined subcarrier location of a start symbol of the control channel and transmit a length signal notifying a length of the control channel through the transceiver at a predetermined subcarrier location of a next transmitting symbol of the start symbol.

The processor may transmit a start signal notifying the start of the control channel through the transceiver at a predetermined subcarrier location of a start symbol of the control channel and transmit a termination signal notifying termination of the control channel through the transceiver at a predetermined subcarrier location of a termination symbol of the control channel.

The processor may determine a HARQ response time of the receiving apparatus in proportion to the TTI.

The transceiver may receive an HARQ response of the control information and data that are transmitted based on the HARQ response time from the receiving apparatus, and the processor may determine retransmission of the control information and data based on the HARQ response.

The processor may add the control channel to a frequency axis using additional subcarriers at the determined TTI.

### BRIEF DESCRIPTION OF THE DRAWINGS

FIG. 1 is a diagram illustrating a radio frame structure in a mobile communication system.

FIG. 2 is a diagram illustrating an example of a subframe structure in a conventional downlink frame.

FIG. 3 is a diagram illustrating an example of a subframe structure in a downlink frame according to an exemplary embodiment of the present invention.

FIGS. 4 to 6 each are diagrams illustrating an example in which a downlink frame transmits control information and data to a plurality of terminals according to an exemplary embodiment of the present invention.

FIG. 7 is a diagram illustrating a HARQ response and HARQ retransmitting process of downlink transmission according to an exemplary embodiment of the present invention.

FIG. 8 is a block diagram illustrating a configuration of a transmitting apparatus according to an exemplary embodiment of the present invention.

FIG. 9 is a block diagram illustrating a configuration of a receiving apparatus according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, in the entire specification and claims, unless explicitly described to the contrary, the word “comprise” and variations such as “comprises” or “comprising” will be understood to imply the inclusion of stated elements but not the exclusion of any other elements.

Hereinafter, a method and apparatus for transmitting in a mobile communication system according to an exemplary embodiment of the present invention will be described in detail with reference to the drawings.

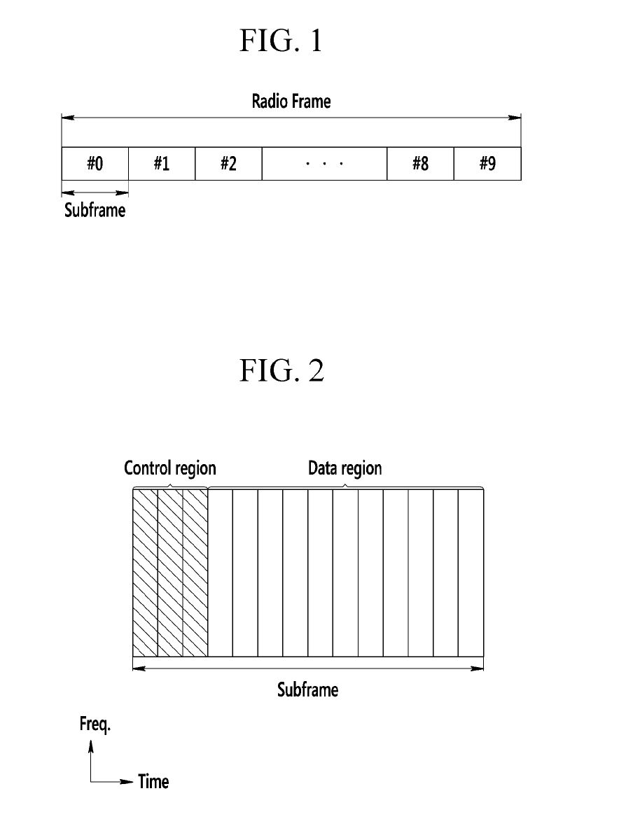

FIG. 1 is a diagram illustrating a radio frame structure in a mobile communication system.

Referring to FIG. 1, a radio frame includes a plurality of subframes #0-#9 in a time domain, and each of the subframes #0-#9 includes at least one transmitting symbol.

In general, in a mobile communication system, a time that is taken for transmitting one subframe is defined to a transmission time interval (TTI). That is, the TTI is used as a minimum time unit for receiving and transmitting data and is set equally to a length of a subframe.

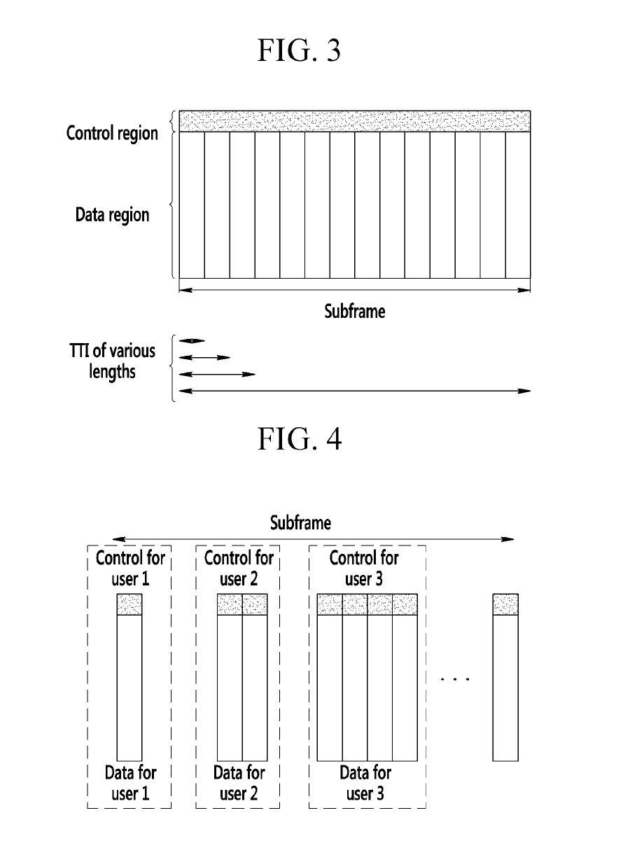

FIG. 2 is a diagram illustrating an example of a subframe structure in a conventional downlink frame.

Referring to FIG. 2, a downlink subframe includes a plurality of transmitting symbols in a time domain.

In a front portion within the downlink subframe, at least one symbol is a control region to which a control channel is allocated, and symbols of the remaining portions of the downlink subframe are a data region to which a data channel is allocated. For example, in a front portion within the downlink subframe, three transmitting symbols may be a control region and the remaining symbols may be a data region.

A control channel such as a Physical Downlink Control Channel (PDCCH), a Physical Control Format Indicator Channel (PCFICH), and a Physical Hybrid ARQ Indicator Channel (PHICH) may be allocated to the control region.

The terminal may decode control information that is transmitted through the PDCCH and receive data that is transmitted through a data channel. The control information that is transmitted through the PDCCH may include location information of a radio resource for data transmission, HARQ related information, MIMO related information, and user identifier (ID). The base station may add a Cyclic Redundancy Check (CRC) for detecting an error to downlink control information to send to the terminal. In the CRC, ID may be scrambled by a scrambling code according to usage or an owner of the PDCCH. In the PDCCH for a specific terminal, ID of the terminal that is allocated from the base station may be scrambled and included in the CRC or may be included separately from a CRC sequence. The number of transmitting symbols in which a control region is included within the subframe may be known through the PCFICH. The PHICH carries a HARQ Acknowledgement (ACK)/NOT-Acknowledgement (NACK) signal in response to uplink transmission.

A physical downlink shared channel (PDSCH) may be allocated to the data region. The PDSCH is a channel for transmitting data.

In this way, the downlink subframe is divided into a control channel and a data channel by a time-division multiplexing (TDM) method. When transmission and allocation for the terminal does not exist in a control channel, such a dividing method has a merit that the terminal may not receive at the remaining data channel segments. However, when reducing a length of a subframe for a service requiring a very short transmitting latency time and response time, a time segment for each of a control channel and a data channel is required, and a control channel segment occupies relatively many segments.

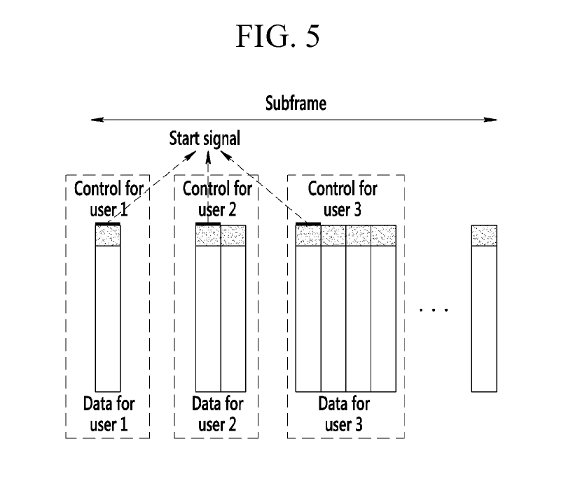

FIG. 3 is a diagram illustrating an example of a subframe structure in a downlink frame according to an exemplary embodiment of the present invention.

Referring to FIG. 3, a downlink subframe includes at least one transmitting symbol in a time domain and includes a plurality of subcarriers in a frequency domain.

According to an exemplary embodiment of the present invention, a minimum time unit of a TTI is set to one transmitting symbol. Therefore, the base station may provide a TTI of various lengths having one or several transmitting symbol lengths shorter than a length of the subframe, and may provide a TTI of a length larger than a length of the subframe. That is, by setting a minimum time unit of a TTI to one transmitting symbol, a TTI of various lengths may be provided in multiple units of a transmitting symbol. Therefore, data of various lengths having various TTIs from a TTI that is formed with only one transmitting symbol to a TTI of a length larger than that of the subframe can be transmitted.

In this case, in the downlink subframe, the control channel and the data channel are divided in a frequency domain. Therefore, in a specific transmitting symbol, a control channel and a data channel for a specific terminal may be simultaneously transmitted from the same transmitting symbol. Therefore, a time segment for a separate control channel is not required, compared with a conventional TDM method.

A minimum basic unit that transmits a control channel is formed with one transmitting symbol in a time axis and the N number of subcarriers on a frequency axis. In this case, the N number of subcarriers are previously defined or the base station notifies the terminal of the N number of subcarriers through broadcasting information.

Subcarriers constituting a basic unit of the control channel may be distributed on frequency domain for frequency diversity.

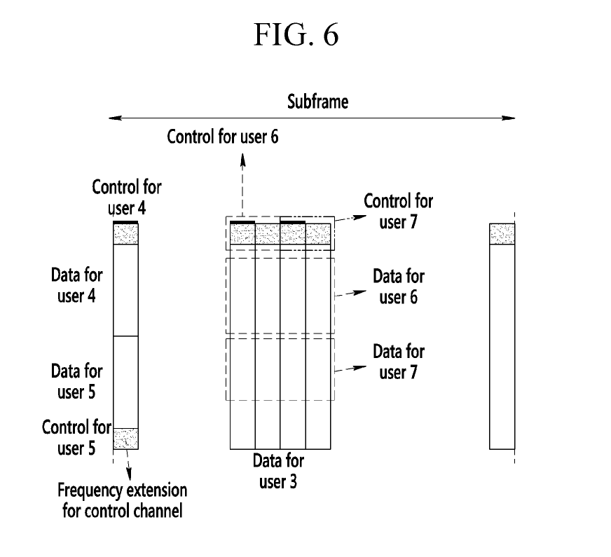

FIGS. 4 to 6 each are diagrams illustrating an example in which a downlink frame transmits control information and data to a plurality of terminals according to an exemplary embodiment of the present invention.

Referring to FIG. 4, the base station determines a TTI based on a quantity of data to transmit to each terminal and a required transmitting latency.

For example, in order to transmit to a terminal 1 (user 1), the base station may determine a TTI to one transmitting symbol length and transmit control information and data for a terminal 1 (user 1) from a first transmitting symbol.

In order to transmit to a terminal 2 (user 2), the base station may determine a TTI to two transmitting symbol lengths and transmit data of a quantity corresponding to a length of two transmitting symbols from the two corresponding transmitting symbols from a second transmitting symbol to a third transmitting symbol to the terminal 2 (user 2). In this case, for the control channel, because two transmitting symbols are used, more control information may be included.

In order to transmit to a terminal 3 (user 3), the base station determines a TTI to four transmitting symbol lengths, and in a fourth transmitting symbol, the base station may transmit data of a quantity corresponding to a length of four transmitting symbols from the four corresponding transmitting symbols from a fourth transmitting symbol to a seventh transmitting symbol to the terminal 3 (user 3). In this case, when control information is fully formed with two transmitting symbols, at a control channel segment of the remaining two transmitting symbols, the control information may be used for transmitting control information in addition to uplink transmission allocation or transmission allocation.

Each terminal (user 1, user 2, and user 3) detects whether control information is control information for the each terminal through a CRC sequence that is scrambled by ID thereof or previously known ID while detecting a control channel segment based on a minimum unit (1 symbol×N subcarriers) of a control channel, and detects a start point location and a length of the control information.

In order to reduce the number of cases of a length of the control channel in which the terminal detects control information, in transmission in which a TTI is the A number of symbols, the base station transmits control information to only a control channel having a symbol length L, where L≦A.

Further, in order to reduce the number of cases for detecting a control channel, the base station may set a length of the control channel to a length of the subframe or less. That is, a length of the control channel is larger than that of the subframe or is set to not transmit over several subframes. In this case, in a long TTI, a length of the data channel may be set longer than that of the subframe according to allocation of the control channel.

Further, the base station may reduce the number of cases of detecting a control channel through a separate control signal. The separate control signal is transmitted at a specific subcarrier location of a start symbol of a control channel and may have only one signal form (sequence). As shown in FIG. 5, a start signal notifying a start point of the control channel may be transmitted at a specific subcarrier location of a start symbol of the control channel.

Alternatively, a separate control signal may be divided into a plurality of length signals notifying a start signal and a length. The start signal is transmitted at a specific subcarrier location of a start symbol of the control channel, and the length signal is transmitted at a specific subcarrier location of a next transmitting symbol of a symbol in which a start signal is transmitted. When a length of the control channel is one transmitting symbol, a length signal is not transmitted.

Further, a separate control signal may be divided into a start signal and a termination signal. The start signal is transmitted at a specific subcarrier location of a start symbol of a control channel, and the termination signal is transmitted at a specific subcarrier location of a termination symbol of a control channel.

Referring to FIG. 6, the base station may simultaneously transmit control information and data from the same transmitting symbol to different terminals. The base station simultaneously transmits control information and data from the same transmitting symbol to different terminals using different subcarriers.

When the base station should transmit data from one transmitting symbol to several terminals, in order to secure an additional control channel resource, the base station may use separate subcarriers in the same transmitting symbol.

When adding a control channel, the base station does not notify transmission of an additional control channel, and each terminal may detect whether an additional control channel is transmitted using a CRC sequence. That is, the terminal detects an original control channel and an additional control channel, and detects additional control information by a CRC test at the additional control channel segment similar to detection of control information by a CRC test at an original control channel segment.

Alternatively, when the base station adds a control channel, the base station may notify whether an additional control channel is transmitted using one information bit in an original control channel. In this case, in the original control channel, in order to enable entire terminals to detect, a CRC that is scrambled by common ID is used. The common ID may be previously determined, and the base station may notify the terminal of the common ID by a broadcasting channel. After the common ID is descrambled in a CRC of a received control channel, the terminal may check the CRC and determine whether a control channel is a control channel thereof based on the detected control information.

Further, when the base station adds a control channel, the base station may transmit a separate control channel additional signal at a specific subcarrier location of a start symbol of a control channel. When a control channel additional signal is detected, the terminal detects an additional control channel at a corresponding transmitting symbol.

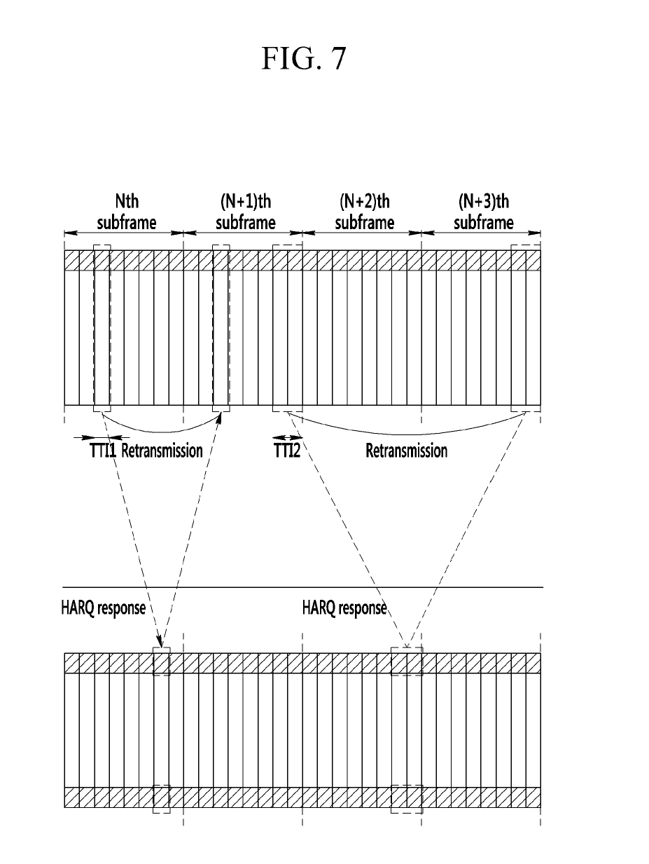

FIG. 7 is a diagram illustrating a HARQ response to downlink transmission and a HARQ retransmitting process according to an exemplary embodiment of the present invention. In FIG. 7, for convenience, it is assumed that one subframe is formed with 7 transmitting symbols.

Data transmission and HARQ response in an uplink has various TTIs that allocate a transmitting symbol to a minimum unit similar to a downlink. A TTI for uplink data transmission is determined according to allocation in a downlink control channel.

Reception of downlink data transmission in a terminal allocates a transmitting symbol to a minimum unit similar to downlink transmission. A HARQ response time in an uplink to downlink transmission is set in proportion to a downlink TTI. When a TTI is short, an encoded data amount is relatively small and thus a decoding time reduces such that a HARQ response time reduces. For example, when a TTI of a downlink is a length of one transmitting symbol, a HARQ response time may be set to a length of four transmitting symbols, and when a TTI of a downlink is set to a length of two transmitting symbols, a HARQ response time may be set to a length of 8 transmitting symbols. Similarly, after initial transmission, a minimum retransmission latency time that can most quickly retransmit may be set in proportion to a TTI length of a downlink.

As shown in FIG. 7, when TTI1 is set to a length of one transmitting symbol, a HARQ response time is set to a length of four transmitting symbols. The base station transmits control information and data from a third transmitting symbol of an N-th subframe to the terminal. The terminal may transmit a HARQ response from a seventh transmitting symbol of an N-th subframe. When a HARQ response is a negative response, the base station may retransmit control information and data from a third transmitting symbol of an (N+1)th subframe.

Further, when TTI2 is set to a length of two transmitting symbols, a HARQ response time is set to a length of 8 transmitting symbols. The base station transmits control information and data from seventh and eighth transmitting symbols of an (N+1)th subframe to the terminal. The terminal may transmit a HARQ response from seventh and eighth transmitting symbols of an (N+2)th subframe. When a HARQ response is a negative response, the base station may retransmit control information and data from seventh and eighth transmitting symbols of an (N+3)th subframe.

In this way, by setting a TTI to a transmitting symbol unit, the TTI can be applied to a service requiring a very short response time.

When a terminal that is separated far from the base station transmits a HARQ response from only one transmitting symbol or only several transmitting symbols according to a TTI of a downlink, a HARQ response may be received with intensity or less in which the base station cannot detect a HARQ response. Therefore, when a far separated terminal transmits, the base station may extend a segment that transmits a HARQ response with a length of more than one transmitting symbol. For transmission by time extension of such a HARQ response, the base station may notify through a downlink control channel or may notify with an upper layer (RRC) message.

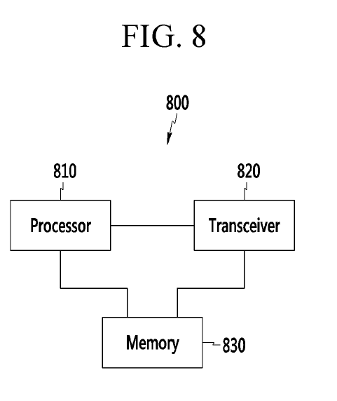

FIG. 8 is a block diagram illustrating a configuration of a transmitting apparatus according to an exemplary embodiment of the present invention.

Referring to FIG. 8, a transmitting apparatus 800 includes a processor 810, a transceiver 820, and a memory 830. The transmitting apparatus 800 may be included in a base station or may be a base station.

The processor 810 sets a TTI for downlink data transmission according to a quantity of data to transmit and/or a required latency time, or controls operation of the transceiver 820 according to the TTI.

The processor 810 may set one transmitting symbol to a TTI and may set a TTI in a multiple unit of a transmitting symbol.

The processor 810 may set one transmitting symbol of a time axis length of a control channel for allocation of data transmission to a basic unit, and may divide a data channel and a control channel by frequency division. The processor 810 may set a length of control information that is transmitted from a control channel to be smaller than or the same as a TTI length in a time axis, and may extend a length of control information using a subcarrier of a frequency axis. That is, a portion of a subcarrier of a data channel may be used for transmission of additional control information.

In order to notify the start of the control channel, the processor 810 may transmit a separate control signal from a start symbol of a control channel through the transceiver 820 using a separate subcarrier.

Further, the processor 810 may set a HARQ response time and a retransmission latency time in proportion to a TTI. That is, a HARQ response transmits a transmitting symbol in a basic unit.

The processor 810 may extend a segment that transmits a HARQ response to at least one transmitting symbol segment.

The transceiver 820 may simultaneously initially transmit or retransmit control information and data from a determined transmitting symbol to the terminal for a TTI. Further, the transceiver 820 may receive a HARQ response that the terminal transmits from an uplink.

The memory 830 stores instructions for performing in the processor 810 or loads and temporarily stores an instruction from a storage device (not shown), and the processor 810 executes an instruction that is stored or loaded at the memory 830.

The processor 810 and the memory 830 are connected through a bus (not shown), and an input/output interface (not shown) may be connected to the bus. In this case, the transceiver 820 is connected to the input/output interface, and a peripheral device such as an input device, a display, a speaker, and a storage device may be connected.

Although a transmitting method and apparatus in the foregoing mobile communication system are not described based on a base station, the transmitting method and apparatus may be similarly applied to a receiving apparatus of a terminal that receives a control signal, a control channel, and a data channel and that transmits a HARQ response.

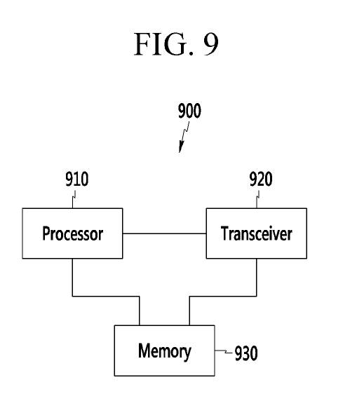

FIG. 9 is a block diagram illustrating a configuration of a receiving apparatus according to an exemplary embodiment of the present invention.

Referring to FIG. 9, a receiving apparatus 900 includes a processor 910, a transceiver 920, and a memory 930. The receiving apparatus 900 may be included in a terminal or may be a terminal.

The processor 910 sets a TTI for a HARQ response based on resource allocation of a base station and controls operation of the transceiver 920 according to the TTI.

The processor 910 may set one transmitting symbol to a TTI according to resource allocation of a base station, and may set a TTI in a multiple unit of a transmitting symbol.

When a control signal, a control channel, and a data channel are received through the transceiver 920, the processor 910 detects control information while detecting a channel segment using the control signal based on a minimum unit of a control channel. Further, the processor 910 detects data that is transmitted from a base station through a data channel. The processor 910 transmits a HARQ response to data to the base station through the transceiver 920 at a predetermined TTI.

The transceiver 920 may transmit a HARQ response from a determined transmitting symbol to the base station for a TTI. Further, the transceiver 920 may receive a control signal, a control channel, and a data channel that are transmitted from the base station.

The memory 930 stores an instruction for performing in the processor 910 or loads and temporarily stores an instruction from a storage device (not shown), and the processor 910 executes an instruction that is stored or loaded at the memory 930.

The processor 910 and the memory 930 are connected through a bus (not shown), and an input/output interface (not shown) may be connected to the bus. In this case, the transceiver 920 is connected to the input/output interface, and a peripheral device such as an input device, a display, a speaker, and a storage device may be connected to the input/output interface.

According to an exemplary embodiment of the present invention, in a mobile communication system, a real-time interactive service requiring a relatively very short response time to a subframe length based on a minimum TTI of a transmitting symbol length can be provided without increase of a transmitting latency time and a response time.

Further, in a mobile communication system, various services requiring various transmitting latency times and response times based on a TTI of various lengths can be effectively provided.

An exemplary embodiment of the present invention may not only be embodied through the above-described apparatus and/or method, but may also be embodied through a program that executes a function corresponding to a configuration of the exemplary embodiment of the present invention or through a recording medium on which the program is recorded, and can be easily embodied by a person of ordinary skill in the art from a description of the foregoing exemplary embodiment.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of transmitting control information and data in a transmitting apparatus of a mobile communication system, the method comprising:
determining a size of a Transmission Time Interval (TTI) in which a transmitting symbol allocates in a minimum unit according to a quantity of data to transmit and a required latency time;
allocating a control channel and a data channel in a frequency domain of a subframe comprising a plurality of transmitting symbols; and
simultaneously transmitting control information and data to at least one receiving apparatus through the control channel and the data channel in the determined TTI in a radio frame comprising a plurality of subframes.

2. The method of claim 1, wherein the simultaneously transmitting of control information comprises transmitting a start signal notifying the start of the control channel at a predetermined subcarrier location of a start symbol of the control channel.

3. The method of claim 1, wherein the simultaneously transmitting of control information comprises:
transmitting a start signal at a predetermined subcarrier location of a start symbol of the control channel; and
transmitting a length signal notifying a length of the control channel at a predetermined subcarrier location of a next symbol of a symbol in which the start signal is transmitted.

4. The method of claim 1, wherein the simultaneously transmitting of control information comprises:
transmitting a start signal at a predetermined subcarrier location of a start symbol of the control channel; and
transmitting a termination signal notifying termination of the control channel at a predetermined subcarrier location of a termination symbol of the control channel.

5. The method of claim 1, wherein the simultaneously transmitting of control information comprises multiplexing and transmitting control information of different receiving apparatuses at the determined TTI using different transmitting symbols of a control channel region.

6. The method of claim 1, wherein the simultaneously transmitting of control information comprises multiplexing and transmitting data of different receiving apparatuses using different subcarriers of a data channel region at the determined TTI.

7. The method of claim 1, wherein the allocating of a control channel comprises adding the control channel to a frequency axis using additional subcarriers.

8. The method of claim 7, wherein the simultaneously transmitting of control information comprises transmitting information of the added control channel using an originally set control channel.

9. The method of claim 7, wherein the simultaneously transmitting of control information comprises transmitting a control signal notifying that the additional control channel exists at a predetermined subcarrier location at a start symbol of the control channel.

10. The method of claim 1, further comprising setting a HARQ response time of the receiving apparatus in proportion to the TTI.

11. The method of claim 10, further comprising:
receiving a HARQ response of the control information and data that are transmitted based on the HARQ response time from the receiving apparatus; and
retransmitting the control information and data when the HARQ response is a negative response.

12. An apparatus that transmits control information and data in a mobile communication system, the apparatus comprising:
a processor that determines a size of a Transmission Time Interval (TTI) that allocates a transmitting symbol in a minimum unit according to a quantity of data to transmit to each receiving apparatus, and a required latency time and that allocates a control channel and a data channel in a frequency domain of a subframe comprising a plurality of transmitting symbols; and
a transceiver that transmits respective control information and data to corresponding receiving apparatuses through the control channel and the data channel at the determined TTI in a radio frame comprising a plurality of subframes.

13. The apparatus of claim 12, wherein the processor transmits a start signal notifying the start of the control channel through the transceiver at a predetermined subcarrier location of a start symbol of the control channel.

14. The apparatus of claim 12, wherein the processor transmits a start signal notifying the start of the control channel through the transceiver at a predetermined subcarrier location of a start symbol of the control channel, and transmits a length signal notifying a length of the control channel through the transceiver at a predetermined subcarrier location of a next transmitting symbol of the start symbol.

15. The apparatus of claim 12, wherein the processor transmits a start signal notifying the start of the control channel through the transceiver at a predetermined subcarrier location of a start symbol of the control channel, and transmits a termination signal notifying termination of the control channel through the transceiver at a predetermined subcarrier location of a termination symbol of the control channel.

16. The apparatus of claim 12, wherein the processor determines a HARQ response time of the receiving apparatus in proportion to the TTI.

17. The apparatus of claim 16, wherein the transceiver receives an HARQ response of the control information and data that are transmitted based on the HARQ response time from the receiving apparatus, and
the processor determines retransmission of the control information and data based on the HARQ response.

18. The apparatus of claim 12, wherein the processor adds the control channel using additional subcarriers to a frequency axis at the determined TTI.
